(19) United States
(12) Patent Application Publication
(10) Pub. No.: US 2009/0110781 A1
(43) Pub. Date: Apr. 30, 2009

(54) Seasoned Food Substrates

(76) Inventors: Ted Baumgartner, Fairview, TX (US); Matt Dashiell, The Colony, TX (US); Ashley Leidolf, Addison, TX (US); Richard Todd Smith, McKinney, TX (US); Karly Soehl, Dallas, TX (US); Carol Tompkins, Frisco, TX (US); Mehrnaz Vafaie, Plano, TX (US)

Correspondence Address: CARSTENS & CAHOON, LLP, P O BOX 802334, DALLAS, TX, 75380, US

(21) Appl. No.: 11/927,019

(22) Filed: Oct. 29, 2007

(51) Int. Cl. A23L 1/09; A23L 1/00

(52) U.S. Cl. 426/103; 426/303

(57) ABSTRACT

A seasoned snack food with a protective coating is provided. The protective coating provides the consumer with reduced tactile messiness, and dissolves quickly in the mouth resulting in rapid flavor delivery.

### BACKGROUND OF THE INVENTION

1. Technical Field

The present invention relates to a method for improving adhesion of a seasoning mixture on a food substrate and more particularly, to a method for protecting a topical seasoning mixture on a snack food substrate whereby transfer of the seasoning mixture from the food substrate onto another substrate, for example, towels or fingers is resisted prior to consumption.

2. Description of Related Art

Topical seasonings are often added to foods, especially snack foods. Tortilla chips, pretzels, crackers, popcorn, extruded collets and numerous other foodstuffs often have topical seasonings applied to them after they have been cooked. The seasonings are typically stored in a powdered form but are usually applied as an oil/seasoning slurry. Examples of topical seasonings include salt, sugar, cheese, chili, garlic, Cajun spice, ranch, sour cream and onion, among many others.

Although such topically seasoned snacks provide consumers with an enjoyable savory flavor experience, there is often an undesirable accumulation of seasoning on the fingers of individuals during consumption, resulting in a messy snacking experience. Prior attempts to produce a topically seasoned snack food that did not easily transfer seasoning to the fingers of consumers have resulted in snack foods that are less messy, but which lack desirable flavor. One such attempt involved including the seasoning in the snack food dough prior to cooking. However, flavors inside the dough would not release into the mouth as quickly as topically applied flavors. Also, most flavors would not survive the high processing temperatures when included in the dough because they are volatized off.

Prior attempts to protectively coat topically seasoned snack foods have not been successful in providing a coating that dissolves quickly enough in the mouth to allow the consumer to enjoy the immediate and sharp experience of tasting the savory seasoning flavors. Some prior attempts in this area have involved using Arabic gum as a coating agent. Arabic gum, however, leaves a minty aftertaste, which is undesirable for savory snack foods. It would be an advance in the art, therefore, to create a topically seasoned snack food substrate which does not easily transfer the topical seasoning to other substrates, but which at the same time quickly delivers the seasoning flavor to the mouth of the consumer when the snack food is eaten.

### SUMMARY OF THE INVENTION

The present invention uses thin dissolvable protective film to coat a seasoned snack food substrate. The dissolvable protective coating is generally applied to a snack food substrate after it has already been topically seasoned. The protective coating is thin and dissolves quickly in the mouth of the consumer.

Hence, this invention produces a topically seasoned snack food substrate with a protective coating that reduces tactile messiness during consumption. In addition, the protective coating on the seasoned snack food dissolves quickly, which releases the underlying seasoning flavor into the consumer's mouth very quickly upon consumption.

In one embodiment, the protective coating is comprised of a maltodextrin and water matrix. In another embodiment, the snack food coating comprises a mixture of corn syrup solids, water and, optionally, salt. In each embodiment, a water based coating slurry is sprayed onto the surface of a snack food substrate that has already been topically seasoned with an oil-based seasoning slurry. The coated, seasoned snack food substrate is then dried to form a durable protective coating that quickly releases the flavors of the seasonings underneath when the snack food is consumed.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flowchart representing one embodiment of the new method.

### DETAILED DESCRIPTION

The present invention relates to a method of producing a topically seasoned snack food product with reduced tactile messiness and quick delivery of seasoning flavor. The present invention also relates to a topically seasoned snack food product characterized by reduced tactile messiness and quick delivery of seasoning flavor. The reduced tactile messiness and rapid delivery of seasoning flavor is provided by way of a novel protective coating on the surface of the snack food which quickly dissolves when it is placed in the consumer's mouth.

The starting point for all embodiments of the present invention is a food substrate. As used herein, the term food substrate refers to any wide variety of snack food items that are commonly commercially available including, but not limited to, extruded collets, potato chips, crackers, multigrain chips, corn chips, tortilla chips, pretzels and numerous other foodstuffs. Tortilla chips, for example, are created by sheeting, cutting and cooking a masa-based dough. By way of another example, extruded collets are created by passing masa-based dough through an extruder and die assembly at high temperature and pressure. When the dough passes out of the extruder through a round die orifice, it quickly expands, becomes a glassy solid and is cut into collets. The collets can be further cooked to a desired final moisture content.

Many such food substrates are seasoned topically following cooking to produce a seasoned snack food. For sturdier food substrates, such as extruded collets, the seasoning can take place in a seasoning tumbler. For more fragile food substrates, such as tortilla chips or potato chips, seasoning can occur using a mono-layer spraying apparatus. The typical seasoning mixture applied to the food substrate comprises an oil-based seasoning slurry which is sprayed onto the substrate and generally comprises oil mixed with seasonings. The oil used for the seasoning slurry can be any edible oil, such as one or a combination of oil derived from corn, soybean, sunflower or other raw materials. Examples of seasonings that are mixed with the slurry include, without limitation, one or a combination of salt, sugars, cheese, butter flavor, chili, garlic, Cajun spice, ranch, sour cream and onion, and many others.

These seasoned snack foods are often packaged and sold in single or multiple serving bags. When they are consumed, the consumer typically reaches one hand into the bag, removes one or more snack food pieces and places them in the consumer's mouth. The oily seasoning on these prior art seasoned snacks tends to adhere to oily human fingers. Consequently, considerable amounts of seasoning can buildup on the consumer's fingers during consumption, which is undesirable for most consumers. The seasoning on these prior art snacks can also rub off on other surfaces, such as napkins and plates.

All embodiments of the present invention overcome the problems present in prior art topically seasoned snack foods by coating a seasoned food product with a thin dissolvable film designed to seal in the topical seasoning, yet quickly release the seasoning flavor very soon after the snack food is placed in the mouth of the consumer. As stated previously, the seasoned food product is typically a cooked snack food substrate that has been topically seasoned with an oil-based seasoning slurry. After the oil-based seasoning slurry has been applied to the snack food substrate, a protective coating layer is applied in accordance with the present invention.

In one embodiment of the present invention, the oil-based seasoning slurry comprises oil and maltodextrin. Maltodextrin is a moderately sweet polysaccharide typically produced from corn starch, and is usually found as a creamy white powder. The U.S. Food and Drug Administration has defined maltodextrin as a nonsweet nutritive saccharide polymer that consists of D-glucose units linked primarily by (alpha)-1,4 bonds and that has a Dextrose Equivalent (DE) of less than 20. Typically, maltodextrin will have a Dextrose Equivalent between about 5 and about 20. Thus, the snack food substrate of this embodiment is topically seasoned with an oil-based seasoning slurry that comprises maltodextrin as one component of the seasoning mixture. Once the substrate has been seasoned with a oil-based seasoning slurry comprising maltodextrin, the seasoned snack food is lightly coated on its outer surface with water and dried to form a thin dissolvable layer on the surface of the seasoned snack food. Without being limited by theory, it is believed that the hygroscopic nature of the maltodextrin in the seasoning allows it to interact with the water through hydrogen bonding and create the thin dissolvable coating on the snack food comprising a water and maltodextrin matrix; formation of the protective coating is further aided because the oil in the seasoning slurry resists water absorption into the snack food substrate, thus forming a boundary that the water based slurry will not penetrate to an appreciable degree. The oil contained in fried snacks also resists water absorption, which further aids the coating process. However, the teachings of the present invention also work with baked snack food substrates that have been seasoned with an oil based seasoning.

Regardless of the actual mechanism, it has been experimentally determined that when water is used to lightly but uniformly coat a snack food substrate that has previously been seasoned with an oil-based seasoning slurry which includes maltodextrin and then dried, a thin protective coating develops on the surface of the seasoned snack food that resists the transfer of seasoning to human fingers during consumption. The water based characteristic of the protective coating furthers the goals of the present invention because the water based protective coating resists mixing with the oils on human fingers, and dissolves quickly in the wet environment present in the human mouth.

In another embodiment, a snack food substrate that has first been seasoned using an oil-based seasoning slurry is then lightly but uniformly coated on its outer surface with a water based slurry comprising water and maltodextrin. In one embodiment, the concentration of maltodextrin in the water based slurry is between about 5% and about 30% by weight. In a preferred embodiment, the concentration of maltodextrin in the water based seasoning slurry is about 10% by weight. When this water based seasoning slurry is used to lightly coat the outer surface of a snack food substrate seasoned with an oil-based seasoning slurry, and then the coated, seasoned snack food is dried, a thin protective film develops on the surface of the snack food that resists the transfer of seasoning to human fingers during consumption and quickly dissolves in the human mouth. Other seasoning ingredients may also be included in the water based slurry that forms the protective coat.

In a preferred embodiment, a snack food substrate that has first been seasoned using an oil-based seasoning slurry is lightly but uniformly coated with a water based slurry comprising water and corn syrup solids, and then dried. Most preferably, the corn syrup solids are derived from waxy corn starch. Waxy corn starch is corn starch that is about 100% amylopectin starch, a branch-chained polysaccharide. Corn syrup solids are small molecular weight molecules derived from the sugars in corn starch, and are defined by the FDA as dried glucose syrups in which the reducing sugar content is 20 Dextrose Equivalent or higher. Typically, the corn syrup solids have a reducing sugar content between about 20 Dextrose Equivalent and about 36 Dextrose Equivalent. Preferably, the water based slurry comprises less than about 30% corn syrup solids by weight. In another preferred embodiment, the water based slurry further comprises less than about 3% salt by weight.

Other film forming agents may also be used to protect and adhere seasoning to the surface of food substrates. Such film forming agents include corn zein protein, alginic acid, and dextrin. These other film forming agents have flavor and performance characteristics that make them suitable for specific food substrates with specific seasoning profiles. However, corn syrup solids slurry is the most preferred embodiment of the present invention because it is broadly applicable due to its high performance level and neutral flavor profile.

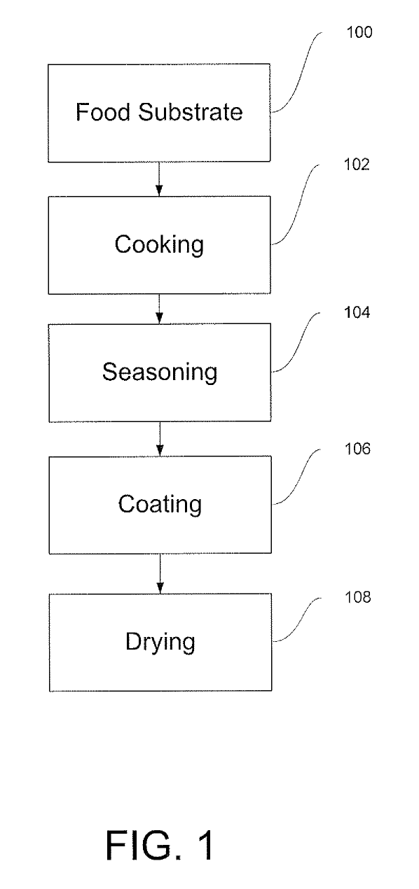

A basic flowchart of one embodiment of the present invention is depicted in FIG. 1. In one embodiment, a snack food substrate 100 is cooked 102 and topically seasoned 104 with an oil-based seasoning spray. The seasoned snack food substrate is then lightly coated 106 with a water based slurry and then dried 108.

According to yet another embodiment, a food substrate is first coated with a water based slurry as described herein, and dried to create a prime coat comprising a protective coating as described herein. Then, the primed food substrate surface is seasoned with an oil-based seasoning spray. According to exemplary embodiments, the food substrate is a hard pretzel or a cracker. Hard pretzels are typically extruded, flour-based baked products that have gone through a caustic bath prior to cooking and dehydration. Crackers are generally manufactured by preparing a dough of flour, water, yeast and sugar. The dough is roiled, laminated, cut, then the cut pieces are cooked, such as by baking. The water based slurry, then the oil based seasoning spray are applied after cooking.

The coating process can occur, in one embodiment, by spraying the seasoned snack food with the water based slurry while it is tumbling inside a tumbler. A tumbler is a cylindrical device, or drum, that rotates and is typically used to add seasoning to a substrate's outer surface area. In another embodiment, the water based slurry is applied to the snack food using a mono-layer curtain spray. The temperature of the water based slurry in one embodiment of the present invention is between about 60° F. and about 200° F. Preferably, the water based slurry is kept above 160° F. to prevent microbial growth.

After a predetermined period of time, the snack food substrate should be lightly but uniformly coated with the water based slurry. In one embodiment, the water based slurry is sprayed into the tumbler for between about 2 minutes and about 5 minutes. In a preferred embodiment, the water based slurry is sprayed into the rotating drum for about 4 minutes.

In one embodiment of the present invention, the tumbler's rotating drum is a perforated drum. Once the seasoned snack food pieces are uniformly coated with the water based slurry, the spray is turned off and hot air is circulated through the perforated rotating drum. In one embodiment, the hot air is circulated at an air temperature between about 180° F. and 220° F. for a snack food product dwell time between about 7 minutes and about 11 minutes. In a preferred embodiment, the hot air is circulated at an air temperature of about 200° F. for a snack food product dwell time of about 9 minutes.

In a more preferred embodiment, after the seasoned snack pieces have been uniformly coated with the water based slurry, they are dried in a single pass or multi-pass hot air oven. This embodiment is preferred over the perforated drum because the single pass or multi-pass oven is less damaging to the protective coating on the seasoned snack pieces as the protective coat is forming. The result is a protective coating that has more structural integrity than a protective coating that is formed as the coated, seasoned snack pieces are tumbling and drying inside a rotating perforated drum. The temperature of the oven is kept to less than about 210° F. because the seasonings can volatize and scorch if the product temperature reaches above about 155° F. Preferably, the oven temperature is about 200° F. No matter which drying method is used, the protective coating forms when the coated, seasoned snack food pieces are dried to a final moisture content below about 3% in one embodiment, and below about 2% in a preferred embodiment, based on the total weight of the snack food product. In all embodiments, the final moisture content of the coated, seasoned snack pieces cannot fall below about 1.6%, or the protective coating breaks down and ceases to function. In a preferred embodiment, the protective coating covers at least 80% of the food substrate surface. In a more preferred embodiment, the protective coating covers at least 90% of the food substrate surface. In a most preferred embodiment, the protective coating covers at least 95% of the food substrate surface. In one embodiment, the protective coating comprises between about 6% and about 8% of the total weight of the snack food product. In a preferred embodiment, the protective coating comprises about 7% of the total weight of the snack food product.

### EXAMPLE

A masa-based dough was extruded through a die assembly at high temperature and pressure to form an expanded extrudate. The extrudate was cut into a plurality of individual collets. The collets were fried to reduce the total moisture content of the collets to about 0.9% by weight. The fried collets were then seasoned in a first tumbler by spraying the collets with an oil-based seasoning slurry. The oil-based seasoning slurry comprised: salt, cheddar cheese and maltodextrin.

The seasoned collets were then transferred to a second tumbler and coated with a water based slurry. The water based slurry comprised, by weight, about 75% water, about 22.5% corn syrup solids, and about 2.5% salt. The particular corn syrup solids used were waxy corn syrup solids sold under the name N-TACK by National Starch & Chemical Company, headquartered in Bridgewater, N.J. The collets were tumbled in the second tumbler with the water based slurry spray for about 4 minutes.

The coated, seasoned collets were then dried in a single pass oven at a temperature of about 200° F. for a dwell time of about 25 minutes until the total moisture content of the collets was reduced to about 1.8% based on the total weight of the seasoned, coated, dried collets. The dried collets were then cooled and sent to be packaged. The resulting snack food pieces were cheese flavored collets covered by a protective coating. The protective coating, on average, covered between about 90% and about 95% of the food product surface. When the finished collets were consumed by hand, the oil-based seasonings did not appreciably adhere to human fingers or other substrates. Furthermore, once the collets were placed in the consumer's mouth, the protective coating quickly dissolved and delivered the underlying seasoning flavor.

While this invention has been particularly shown and described with reference to a preferred embodiment, it will be understood by those skilled in the art that various changes in form and detail may be made therein without departing from the spirit and scope of the invention.

What is claimed is:

1. A snack food comprising:
a food substrate having an outer surface;
an oil-based seasoning covering said outer surface of said food substrate, wherein said oil based seasoning comprises oil and maltodextrin;
a protective coating over the oil-based seasoning, wherein said protective coating comprises a water and maltodextrin matrix; and
a total moisture content of between about 1.6% and about 3%, based upon the total weight of the snack food.

2. The snack food of claim 1 wherein said food substrate comprises at least one of a fried food substrate, a baked food substrate and an extruded food substrate.

3. The snack food of claim 1 wherein said protective coating further comprises corn syrup solids.

4. The snack food of claim 1 wherein said protective coating further comprises corn syrup solids with a Dextrose Equivalent of 20 or greater.

5. The snack food of claim 1 wherein said total moisture content is between about 1.6% and about 2%, based upon the total weight of the snack food.

6. The snack food of claim 1 wherein said protective coating covers at least about 80% of said outer surface of said food substrate.

7. The snack food of claim 1 wherein said protective coating covers at least about 90% of said outer surface of said food substrate.

8. The snack food of claim 1 wherein said protective coating comprises between about 6% and about 8% of the snack food, based upon total weight of the snack food.

9. A method of making a snack food, said method comprising:
providing a food substrate with an outer surface;
coating said outer surface of said food substrate with an oil-based seasoning comprising oil and maltodextrin to produce a seasoned food substrate;
coating said seasoned food substrate with a water based slurry comprising water to produce a coated seasoned food substrate;
drying said coated seasoned food substrate to a final moisture content between about 1.6% and about 3%, based upon total snack food weight, to produce a snack food with a protective coating.

10. The method of claim 9 wherein said water based slurry further comprises maltodextrin.

11. The method of claim 10 wherein said water based slurry further comprises between about 5% and about 30% maltodextrin by weight.

12. The method of claim 9 wherein said water based slurry further comprises corn syrup solids.

13. The method of claim 9 wherein said water based slurry further comprises corn syrup solids having a Dextrose Equivalent of at least 20.

14. The method of claim 9 wherein said water based slurry further comprises between about 15% and about 30% corn syrup solids.

15. The method of claim 9 wherein said drying comprises tumbling said coated seasoned food substrate in a perforated drum and circulating air through the perforated drum at an air temperature between about 190° F. and about 210° F. for a dwell time between about 7 minutes and about 11 minutes.

16. The method of claim 9 wherein said drying comprises passing said coated seasoned food substrate through a single pass oven at between about 190° F. and about 210° F. with a dwell time between about 20 minutes and about 30 minutes.

17. The method of claim 9 wherein said drying comprises passing said coated seasoned food substrate through a multi-pass oven at between about 190° F. and about 210° F. with a dwell time between about 20 minutes and about 40 minutes.

18. The method of claim 9 wherein said final moisture content is between about 1.6% and about 2%>based upon total snack food weight.

19. The method of claim 9 wherein said final moisture content is about 1.8%, based upon total snack food weight.

20. The method of claim 9 wherein said protective coating comprises between about 6% and about 8% of said snack food, based upon total snack food weight.

21. A method of making a snack food, said method comprising:
providing a food substrate with an outer surface;
coating said outer surface of said food substrate with a water based slurry comprising water and maltodextrin to produce a coated food substrate;
drying said coated food substrate to a moisture content between about 1.6% and about 3%, based upon total snack food weight, to dried coated food substrate; and
coating said dried coated food substrate with an oil-based seasoning comprising oil and maltodextrin to produce a seasoned food substrate.

22. The method of claim 21 wherein said water based slurry further comprises corn syrup solids.

23. The method of claim 21 wherein said food substrate comprises a pretzel.

24. A snack food comprising:
a food substrate having an outer surface;
a protective coating covering said outer surface of said food substrate, wherein said protective coating comprises a water and maltodextrin matrix;
an oil-based seasoning over said protective coating, wherein said oil based seasoning comprises oil and maltodextrin;
a total moisture content of between about 1.6% and about 3%, based upon the total weight of the snack food.

25. The snack food of claim 1 wherein said protective coating further comprises corn syrup solids.
